(19) United States
(12) Patent Application Publication
(10) Pub. No.: US 2007/0278217 A1
(43) Pub. Date: Dec. 6, 2007

(54) Magnetic head and method of manufacturing the same

(75) Inventors: Hideaki Daimatsu, Kawasaki (JP); Takashi Ito, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/634,534

(22) Filed: Dec. 6, 2006

(30) Foreign Application Priority Data
May 31, 2006 (JP) 2006-150844

(51) Int. Cl. H05B 6/10

(52) U.S. Cl. 219/633

(57) ABSTRACT

There is provided a magnetic head where a heater is reliably incorporated into the magnetic head and the fly height of the magnetic head above a medium surface can be reliably controlled using thermal expansion due to heat from the heater. A method of manufacturing the magnetic head is also provided. The method of manufacturing includes, as steps of manufacturing the heater, a step of forming a silicon dioxide layer on the surface of a substrate, a step of forming, as heater forming layers, a tantalum layer, a heating layer, and another tantalum layer in that order on the surface of the silicon dioxide layer, a step of patterning a resist in accordance with a planar pattern of the heater to cover the surface of the heater forming layers, a step of forming the heater in a pattern by carrying out ion milling on the heater forming layers with the resist as a mask, a step of sputtering a silicon dioxide layer with a greater thickness than a thickness of the heater in a state where the surface of the heater has been covered with the resist, and a step of removing the resist together with the silicon dioxide layer that covers an outer surface of the resist from the surface of the heater by lifting off.

### BACKGROUND OF THE INVENTION

1. Field of the Invention

The present invention relates to a magnetic head and a method of manufacturing the same, and in more detail to a magnetic head with a heater that adjusts the interval between the magnetic head (i.e., the head slider) and a medium, and a method of manufacturing the same.

2. Related Art

In recent years, the recording density used in a magnetic disk apparatus has become extremely high. As the recording density has increased, the interval between the magnetic head and the medium, (i.e., the fly height of the head) has become minute, making it necessary to control the distance between the magnetic head and the medium with high precision. As a method of controlling the distance between the magnetic head and the medium with high precision, a method where a heater is incorporated into the head slider and the current supplied to the heater is controlled to control the thermal expansion of the head slider and thereby control the distance between the magnetic head and the medium has been investigated (see, for example, Patent Document 1).

### Patent Document 1

Japanese Laid-Open Patent Publication No. 2005-63523

### SUMMARY OF THE INVENTION

With the conventional head slider in which a heater is incorporated, the heater is incorporated into the substrate of the head slider, which means that the temperature of the entire head slider is controlled to control the thermal expansion of the head slider. On the other hand, as shown in FIG. 3, the present applicant is investigating a method where a heater 20 is disposed between a coil 14 and a lower magnetic pole layer 16 formed in a write head 10 of a magnetic head. With this construction, the current supplied to the heater 20 is controlled to adjust mainly the amount by which the write head 10 protrudes toward the medium surface (i.e., the thermal expansion of the write head 10), thereby adjusting the fly height.

The magnetic head shown in FIG. 3 includes a read head 8, where a reproduction MR element 5 is sandwiched between a lower shield layer 6 and an upper shield layer 7, and a write head 10 that includes a lower front end magnetic pole 12 and an upper magnetic pole 13 disposed on either side of a write gap 11. In the write head 10, a coil 14 for producing a write magnetic field between the lower front end magnetic pole 12 and the upper magnetic pole 13 is sandwiched between the lower magnetic pole layer 16 and the upper magnetic pole 13 and is wound around a linking portion 15.

In this example, the heater 20 is disposed behind the linking portion 15 and between the first layer of the coil 14a and the lower magnetic pole layer 16 and is electrically insulated from such parts. The heater 20 is wound in the form of a flat coil and positioned behind the write head 10. FIG. 3 shows part of the heater 20.

The magnetic head is formed by successively laminating magnetic layers, insulating layers, and the like in predetermined patterns on the wafer substrate. In the same way as the conventional layer forming processes that form the magnetic head, the heater 20 is formed during the manufacturing process of the magnetic head in a predetermined pattern, but as shown in FIG. 3, since the heater 20 is formed between the lower magnetic pole layer 16 and the coil 14a, it is believed that there will be a problem in that the part where the heater 20 is formed will bulge upward, resulting in the coil 14 becoming displaced and an inability to form the correct coil pattern, and a problem that if there is poor attachment between the heater 20 and the insulating layer, the heater 20 will become separated from the insulating layer and will corrode.

The present invention was conceived to solve the problems described above and it is an object of the present invention to provide a magnetic head where a heater can be reliably incorporated with the heater electrically insulated from the magnetic layer and recording coil that construct the magnetic head and where the fly height between the magnetic head and medium surface can be appropriately controlled using thermal expansion caused by heating by the heater.

To achieve the stated object, the present invention is a magnetic head in which a heater for controlling a fly height of the magnetic head above a medium surface is incorporated, wherein the heater is formed by providing tantalum layers on both surfaces of a heating layer (TiW, NiCu, NiCr, NiFe) to sandwich the heating layer (TiW, NiCu, NiCr, NiFe), and a silicon dioxide layer is provided as an insulating layer that electrically insulates the heater and a conductive portion that constructs the magnetic head.

The heater may be provided between a lower magnetic pole layer and a recording coil of a write head, and a silicon dioxide layer may be provided as the insulating layer between the lower magnetic pole layer and the heater and between windings of the heater.

By forming the surface of the heater and the surface of the silicon dioxide layer provided on the same layer as the heater as surfaces with a uniform height, the magnetic layer and recording coil of the magnetic head can be formed with high precision.

Also, by providing an alumina layer on the heater and a surface of the silicon dioxide layer provided on the same layer as the heater, it is possible to ensure that the heater and the magnetic layer and/or the recording coil that construct the magnetic head are electrically insulated from one another reliably.

A method of manufacturing a magnetic head according to the present invention manufactures the magnetic head described above and includes, as steps of manufacturing the heater: a step of forming a silicon dioxide layer on a surface of a substrate; a step of forming a tantalum layer, a heating layer (TiW, NiCu, NiCr, NiFe), and another tantalum layer in that order as heater forming layers on a surface of the silicon dioxide layer; a step of patterning a resist in accordance with a planar pattern of the heater to cover a surface of the heater forming layers; a step of forming the heater in a pattern by carrying out ion milling on the heater forming layers with the resist as a mask; a step of sputtering a silicon dioxide layer with a greater thickness than a thickness of the heater in a state where the surface of the heater is covered with the resist; and a step of removing the resist together with the silicon dioxide layer that covers an outer surface of the resist from the surface of the heater by lifting off.

After the step of removing the resist, the surface of the heater and the surface of the silicon dioxide layer formed on the same layer as the heater may have a uniform height.

In the method of manufacturing the magnetic head, after a lower magnetic pole layer of a write head has been formed on the surface of the substrate, the heater may be formed between a lower magnetic pole layer and a recording coil by carrying out: a step of forming a silicon dioxide layer on a surface of the lower magnetic pole layer; a step of forming the heater forming layers; a step of patterning the resist to cover the heater forming layers; a step of sputtering silicon dioxide in a state where the surface of the heater forming layers is covered with the resist; and a step of removing the resist together with the silicon dioxide layer from the surface of the heater by lifting off.

According to the magnetic head and method of manufacturing the same according to the present invention, since the heater forming layers are constructed by sandwiching a heating layer (titanium-tungsten, nickel-copper, nickel-chromium, nickel-iron) in the thickness direction with tantalum layers, it is possible to prevent corrosion of the titanium-tungsten and to ease the membrane stress of the heating layer (titanium-tungsten, nickel-copper, nickel-chromium, nickel-iron), thereby making it possible to prevent detachment of the heater from the insulating layers. Also, by using silicon dioxide layers as the insulating layers of the heater, it is possible to effectively suppress the conductance of heat from the heater, which makes it possible to prevent overheating of the MR element and to prevent heat from escaping from the heater, thereby making it possible to effectively cause the magnetic head to protrude toward the medium surface due to the thermal expansion caused by the heat from the heater.

### BRIEF DESCRIPTION OF THE DRAWINGS

The aforementioned and other objects and advantages of the present invention will become apparent to those skilled in the art upon reading and understanding the following detailed description with reference to the accompanying drawings.

In the drawings:

FIGS. 1A to 1D are diagrams useful in showing manufacturing steps of a magnetic head according to the present invention;

FIGS. 2A to 2D are diagrams useful in showing manufacturing steps of a magnetic head according to the present invention; and

FIG. 3 is a cross-sectional view showing the construction of a magnetic head equipped with a heater.

### DESCRIPTION OF THE PREFERRED EMBODIMENTS

Preferred embodiments of the present invention will now be described with reference to the attached drawings.

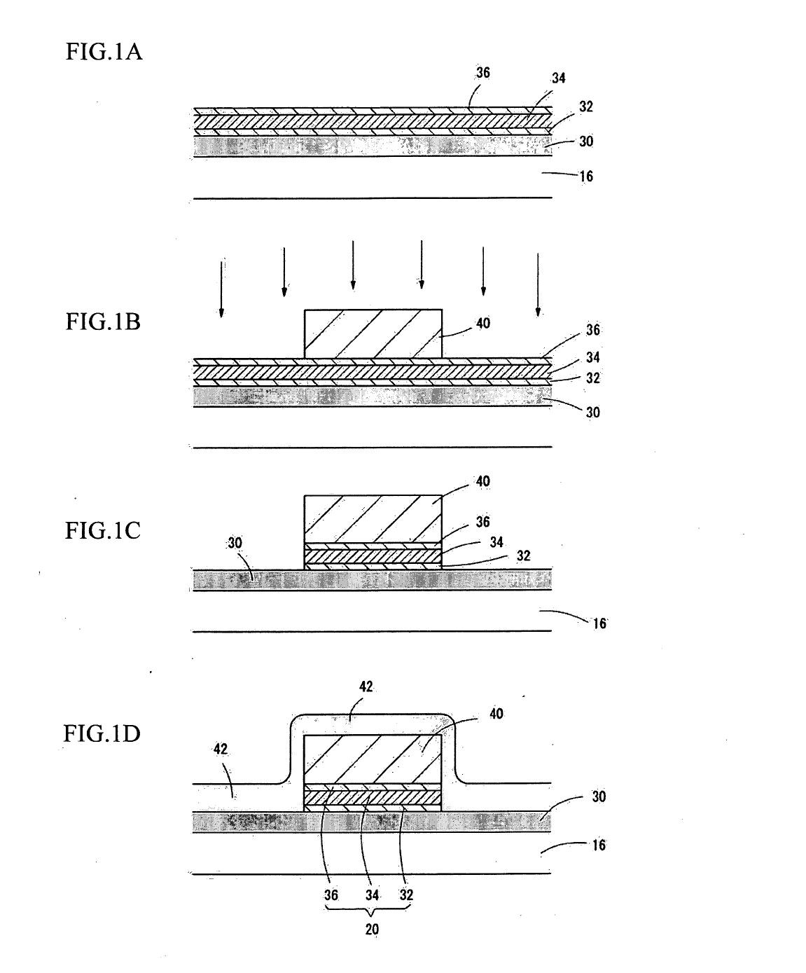

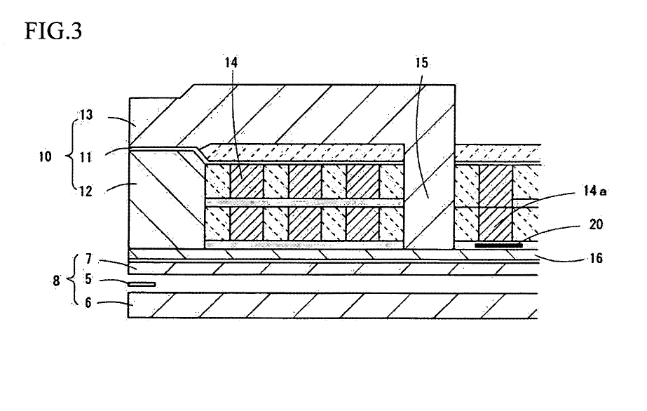

FIGS. 1A to 1D show manufacturing steps in a method of manufacturing a magnetic head according to the present invention. Note that as shown in FIG. 3, the magnetic head according to the present invention is constructed so that a heater 20 is disposed between and electrically insulated from a coil 14a and a lower magnetic pole layer 16 that construct a write head 10 of the magnetic head. The heater 20 is electrically insulated from the lower magnetic pole layer 16 and is formed in the shape of a flat coil. FIGS. 1A to 1D show manufacturing steps that form the heater 20 on the lower magnetic pole layer 16, and in these drawings, one winding of the heater 20 formed as a flat coil is shown in cross section.

The lower magnetic pole layer 16 is formed with a predetermined thickness by electroplating a magnetic material such as FeNi after a lower shield layer 6, an MR element 5, and an upper shield layer 7 that construct a read head 8 have been formed in that order on the surface of a substrate (Al₂O₃.TiC).

FIG. 1A shows a state where after the lower magnetic pole layer 16 has been formed on the surface of the substrate, a silicon dioxide (SiO₂) layer 30 has been formed by sputtering as a layer for electrically insulating the heater 20 from the lower magnetic pole layer 16, and then heater forming layers composed of a first Ta layer 32, a heating layer 34, and a second Ta layer 36 have been formed by forming layers of tantalum (Ta), a heating layer (TiW, NiCu, NiCr, NiFe) and tantalum in that order. The first Ta layer 32, the heating layer 34, and the second Ta layer 36 are each formed by sputtering.

The silicon dioxide layer 30 is provided to electrically insulate the heater 20 and the lower magnetic pole layer 16 from one another and is formed with a thickness of around 100 nm.

The first Ta layer 32, the heating layer 34, and the second Ta layer 36 form a coil pattern portion (a main resistance portion) of the heater 20, and were formed with respective thicknesses of 5 nm, 80 nm, and 5 nm in the present embodiment.

FIG. 1B shows a state where the surface of the substrate has been covered with a resist 40 used to pattern the heater forming layers composed of the first Ta layer 32, the heating layer 34, and the second Ta layer 36 in accordance with a planar pattern of the heater 20 and the resist 40 has then been patterned by carrying out exposing and developing operations to cover parts that will become the heater 20 with the resist 40.

After the resist 40 has been patterned, ion milling is carried out to remove the parts of the heating forming layers that are exposed (i.e., parts of the heating forming layers that are not covered by the resist 40) from the surface of the silicon dioxide layer 30.

FIG. 1C shows a state where out of the heater forming layers composed of the first Ta layer 32, the heating layer 34, and the second Ta layer 36, parts covered by the resist 40 have been left on the surface of the silicon dioxide layer 30. Such parts covered by the resist 40 form the heater 20.

FIG. 1D shows a state where silicon dioxide has been sputtered onto the surface of the substrate so that spaces between the windings of the heater 20 are filled with insulating material. The silicon dioxide is formed with a thickness that is equal to or greater than the total thickness of the first Ta layer 32, the heating layer 34, and the second Ta layer 36 that form the heater 20. By sputtering the silicon dioxide, a silicon dioxide layer 42 is formed between windings of the heater 20 and the upper surface and the side surfaces of the resist 40 are simultaneously covered with the silicon dioxide layer 42.

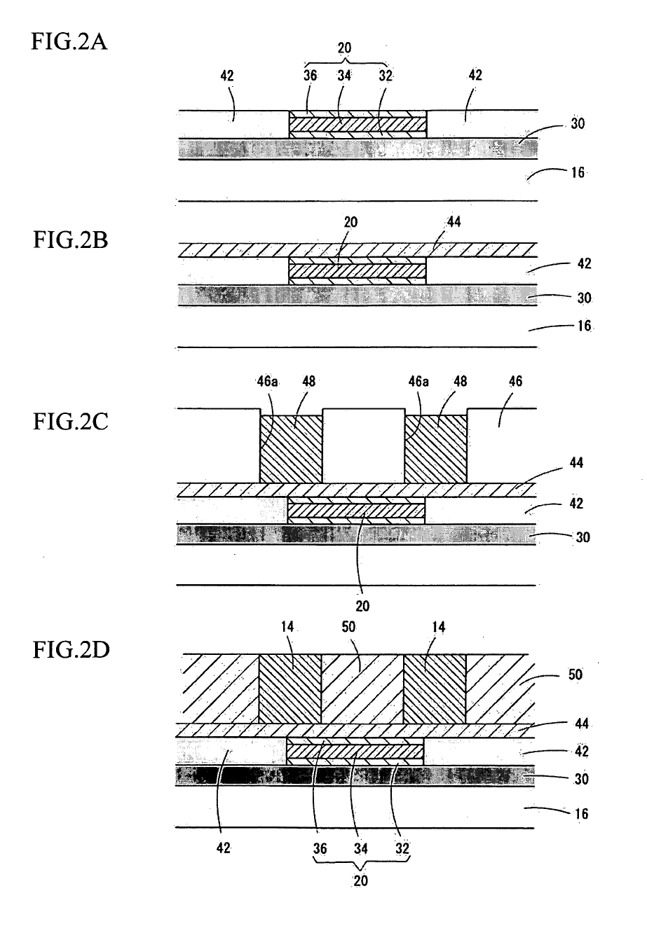

FIG. 2A shows a state where the resist 40 that covers the surface of the heater 20 has been lifted off and thereby separated from the heater 20. If the resist 40 covering the surface of the heater 20 is removed by lifting off, the silicon dioxide layer 42 that covers the surface and side surface of the resist 40 are removed together with the resist 40, thereby leaving the silicon dioxide layer 42 between the windings of the heater 20. FIG. 2A shows a state where the surface of the heater 20 and the surface of the silicon dioxide layer 42 have been formed as surfaces with a uniform height.

FIG. 2B shows a state where an alumina layer 44 has been formed by sputtering alumina onto the surface of the substrate so that the coil 14 of the write head 10 can then be formed in a state where the coil 14 is electrically insulated from the heater 20.

After the surface of the substrate has been covered with the alumina layer 44, a resist 46 is formed to cover the surface of the substrate and then the resist 46 is exposed and developed in accordance with a pattern of the coil 14 to be formed in the write head 10 to form a concave channel 46a in the resist 46 in accordance with the planar pattern of the coil 14.

FIG. 2C shows a state where copper plating 48 that forms a conductive portion of the coil 14 has accumulated inside the concave channel 46a by carrying out electroplating. FIG. 2D shows a state where after the resist 46 has been removed, alumina has been sputtered to fill the spaces between neighboring windings of the coil 14 with alumina 50.

In this way, after the silicon dioxide layer 30 and the alumina layer 44 have been formed as insulating layers for electrically insulating the lower magnetic pole layer 16 and the coil 14, the write head 10 including the lower front end magnetic pole 12, the upper magnetic pole 13, the write gap 11, the coil 14, and the like can be manufactured using the manufacturing steps of a conventional magnetic head.

In the present embodiment, since the heater 20 and the silicon dioxide layer 42 that fills the gaps between the windings of the heater 20 are formed flush in the step of manufacturing the heater 20, the parts where the heater 20 has been formed do not partially bulge outward, and therefore it is possible to form the coil 14 with high precision.

Also, in the present embodiment, the heater 20 is formed with the heating layer 34 sandwiched in the thickness direction between the first Ta layer 32 and the second Ta layer 36, so that the heating layer 34 is not exposed to the outside. Accordingly, the heating layer 34 that is susceptible to corrosion is not affected by the external environment, thereby improving the reliability of the magnetic head. Also, by sandwiching the heating layer with tantalum, it is possible for the tantalum to ease the membrane stress of the heating layer, thereby making it possible to prevent the heater 20 from being susceptible to detachment from the insulating layers.

Also, in the present embodiment, by forming the insulating layer that is the base layer of the heater 20 as the silicon dioxide layer 30 whose thermal conductance is lower than that of alumina and similarly filling the spaces between the windings of the coil that forms the heater 20 with the silicon dioxide layer 42, it is possible to suppress the conductance of heat from the heater 20 compared to the case where alumina is used for the insulating layers. By suppressing the conductance of heat from the heater 20 in this way, it is possible to suppress the conductance of heat from the heater 20 to a TMR element and thereby to avoid deterioration in the characteristics of the TMR element which has comparatively low resistance to heat.

Also, by suppressing the conductance of heat from the heater 20, heat can be prevented from escaping from the heater 20 and therefore the write head 10 can be effectively caused to protrude due to the thermal expansion caused by the heat from the heater 20.

Note that although the magnetic head in the embodiment described above is constructed with the heater 20 disposed between the first layer of the coil 14a and the lower magnetic pole layer 16, the heater 20 is not limited to being disposed at the position described in the above embodiment. For example, for a product like the magnetic head shown in FIG. 3 which is equipped with a two-layer coil or a multi-layer coil with three or more layers as the write head, it is possible to dispose the heater between the first and second layers of the coil or between the uppermost layer of the coil and the upper magnetic pole.

What is claimed is:

1. A magnetic head in which a heater for controlling a fly height of the magnetic head above a medium surface is incorporated,
wherein the heater is formed by providing tantalum layers on both surfaces of a heating layer to sandwich the heating layer, and
a silicon dioxide layer is provided as an insulating layer that electrically insulates the heater and a conductive portion that constructs the magnetic head.

2. A magnetic head according to claim 1,
wherein the heater is provided between a lower magnetic pole layer and a recording coil of a write head, and
a silicon dioxide layer is provided as the insulating layer between the lower magnetic pole layer and the heater and between windings of the heater.

3. A magnetic head according to claim 1,
wherein a surface of the heater and a surface of the silicon dioxide layer provided on the same layer as the heater are formed as surfaces with a uniform height.

4. A magnetic head according to claim 2,
wherein a surface of the heater and a surface of the silicon dioxide layer provided on the same layer as the heater are formed as surfaces with a uniform height.

5. A magnetic head according to claim 3,
wherein an alumina layer is provided on the heater and a surface of the silicon dioxide layer provided on the same layer as the heater.

6. A magnetic head according to claim 4,
wherein an alumina layer is provided on the heater and a surface of the silicon dioxide layer provided on the same layer as the heater.

7. A method of manufacturing a magnetic head in which a heater for controlling a fly height of the magnetic head above a medium surface is incorporated, comprising, as steps of manufacturing the heater:
a step of forming a silicon dioxide layer on a surface of a substrate;
a step of forming a tantalum layer, a heating layer, and another tantalum layer in that order as heater forming layers on a surface of the silicon dioxide layer;
a step of patterning a resist in accordance with a planar pattern of the heater to cover a surface of the heater forming layers;
a step of forming the heater in a pattern by carrying out ion milling on the heater forming layers with the resist as a mask;
a step of sputtering a silicon dioxide layer with a greater thickness than a thickness of the heater in a state where the surface of the heater is covered with the resist; and
a step of removing the resist together with the silicon dioxide layer that covers an outer surface of the resist from the surface of the heater by lifting off.

8. A method of manufacturing a magnetic head according to claim 7, further comprising, after the step of removing the resist, a step of smoothing that grinds the surface of the heater and the surface of the silicon dioxide layer formed on the same layer as the heater so that the surfaces have a uniform height.

9. A method of manufacturing a magnetic head according to claim 8,
wherein after a lower magnetic pole layer of a write head has been formed on the surface of the substrate, the heater is formed between a lower magnetic pole layer and a recording coil by carrying out:
a step of forming a silicon dioxide layer on a surface of the lower magnetic pole layer;
a step of forming the heater forming layers;
a step of patterning the resist to cover the heater forming layers;
a step of sputtering silicon dioxide in a state where the surface of the heater forming layers is covered with the resist; and
a step of removing the resist together with the silicon dioxide layer from the surface of the heater by lifting off.
